(19) United States
(12) Patent Application Publication
(10) Pub. No.: US 2020/0211512 A1
(43) Pub. Date: Jul. 2, 2020

(54) HEADSET ADJUSTMENT FOR OPTIMAL VIEWING

(71) Applicant: Facebook Technologies, LLC, Menlo Park, CA (US)

(72) Inventors: Sebastian Sztuk, Menlo Park, CA (US); Javier San Agustin Lopez, Palo Alto, CA (US); Anders Bo Pedersen, San Francisco, CA (US); Martin Henrik Tall, Redwood City, CA (US)

(21) Appl. No.: 16/400,984

(22) Filed: May 1, 2019

Related U.S. Application Data
(60) Provisional application No. 62/785,577, filed on Dec. 27, 2018.

(51) Int. Cl. G09G 5/38; G06F 3/01

(52) U.S. Cl. CPC G09G 5/38; G09G 2354/00; G06F 3/013

(57) ABSTRACT

A wearable display system includes a headset and a display module in the headset. The display module includes an electronic display for displaying images to the user. A camera is provided in the headset. The camera is configured for obtaining an image of an eye area of the user. A processing module of the wearable display system is configured to use the camera to determine an offset of a current eye position of the user wearing the headset, relative to an optimal eye position in an eyebox of the headset. The processing module is configured to determine a direction of adjustment of the headset to lessen the offset and provide an instruction to perform the adjustment of the headset in the determined direction.

### REFERENCE TO RELATED APPLICATION

The present application claims priority from U.S. Provisional Application No. 62/785,577 filed on Dec. 27, 2018, and incorporated herein by reference in its entirety.

### TECHNICAL FIELD

The present disclosure relates to wearable headsets, and in particular to wearable visual displays and methods therefor.

### BACKGROUND

Head-mounted displays (HMDs), near-eye displays (NEDs), and other wearable display systems can be used to present virtual scenery to a user, or to augment real scenery with dynamic information, data, or virtual objects. The virtual reality (VR) or augmented reality (AR) scenery can be three-dimensional (3D) to enhance the experience and to match virtual objects to real objects observed by the user. Eye position and gaze direction, and/or orientation of the user may be tracked in real time, and the displayed scenery may be dynamically adjusted depending on the user's head orientation and gaze direction, to provide a better experience of immersion into a simulated or augmented environment.

Optical block of a wearable AR/VR display often has a “sweet spot”, i.e. a geometrical area for a user's eye where the views of the virtual or augmented scenery are optimal in terms of image quality, field of view, image artifacts, eye tracking accuracy and fidelity, etc. It is desirable to place both eyes of the user into corresponding areas of optimal performance of the optics block. This task may be difficult to achieve in practice in view of a great variety of people's head shapes and inter-pupil distances (IPDs), and different facial features such as eye recess, forehead and nose protrusion, etc.

### BRIEF DESCRIPTION OF THE DRAWINGS

Exemplary embodiments will now be described in conjunction with the drawings, in which:

FIG. 1 is a top cross-sectional view of a wearable display system of the present disclosure;

FIG. 2 is a top schematic view of a display system headset superimposed with visual cues for headset adjustment, according to some embodiments;

FIG. 3 is a flow chart of a method for a headset adjustment;

FIG. 4 is a flow chart of a method for a headset adjustment by displaying a sequence of instructional screens to a user on an electronic display of the headset;

FIGS. 5A to 5F are example instructional screens displayed on the electronic display of the headset for guiding the user through an X-axis alignment of the headset according to the method of FIG. 4;

FIGS. 6A and 6B are example instructional screens displayed on the electronic display of the headset for Z-axis and Y-axis alignment of the headset, respectively;

FIGS. 7A and 7B are example instructional screens displayed on the electronic display of the headset for IPD adjustment of the headset;

FIG. 8 is a top cross-sectional view of a wearable display system of the present disclosure including motorized display units and an eye-tracking system;

FIG. 9 is a top cross-sectional view of a wearable display system of the present disclosure including motorized display units and a 3D face scanning system;

FIG. 10 is a flow chart of a method for an automated headset alignment;

FIG. 11A is an isometric view of a head-mounted display of the present disclosure;

FIG. 11B is a block diagram of a virtual reality system including the headset of FIG. 11A; and

FIG. 12 is a functional block diagram of an autonomous wearable display system of the present disclosure.

### DETAILED DESCRIPTION

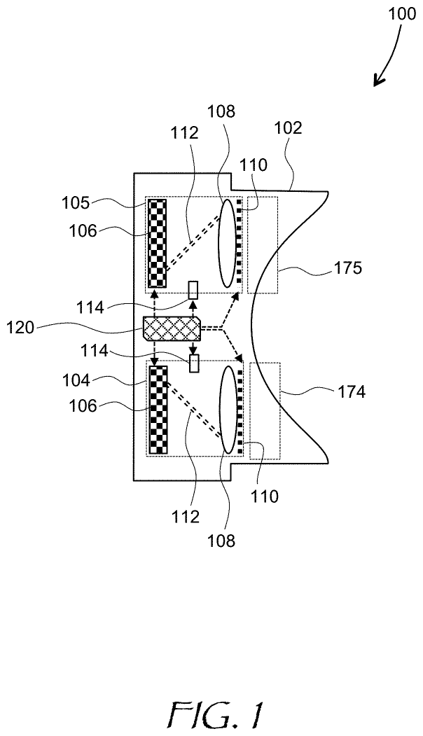

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. In FIGS. 1, 2, 8, and 9, similar reference numerals refer to similar elements.

In accordance with the present disclosure, information obtainable from sensor(s) of a wearable display headset may be used to facilitate a correct placement of the headset on one's head, and a correct adjustment of the headset. For example, a sensor such as an eye tracking camera may be used to determine the user eyes location relative to the camera during an initial setup procedure. This information may be used to e.g. adjust the distance between the display modules or display module portions presenting images to each eye to correspond to the inter-pupil distance (IPD) of the current user. This information may also be used to guide the user to adjust the headset location on the user's head. The adjustment may be manual or automatic.

In accordance with the present disclosure, there is provided a method for a headset adjustment, the headset comprising a sensor and a display module comprising an electronic display for displaying images to a user, the method comprising using the sensor to determine an offset of a current eye position of the user wearing the headset relative to an optimal eye position in an eyebox of the headset; determining a direction of adjustment of the headset to lessen the offset; and providing an instruction to perform the adjustment of the headset in the determined direction.

In accordance with the present disclosure, there is provided a non-transitory memory having stored thereon instructions which, when executed by a processor, cause the processor to use a sensor of a headset comprising a display module comprising an electronic display for displaying images to a user, to determine an offset of a current eye position of the user wearing the headset relative to an optimal eye position in an eyebox of the headset; determine a direction of adjustment of the headset to lessen the offset; and provide an instruction to perform the adjustment of the headset in the determined direction.

In accordance with the present disclosure, there is further provided a wearable display system comprising a headset and a processing module. The headset includes a headset body, a display module in the headset body and the display module comprising an electronic display for displaying images to a user of the headset. The processing module is configured to use the sensor to determine an offset of a current eye position of the user wearing the headset, relative to an optimal eye position in an eyebox of the headset, determine a direction of adjustment of the headset to lessen the offset; and provide an instruction to perform the adjustment of the headset in the determined direction.

Referring to FIG. 1, a wearable display system 100 includes a headset body 102 and left 104 and right 105 display modules disposed in the headset body 102. The left display module 104 is configured to present an image to the left eye of a user, and the right display module 105 is configured to present an image to the right eye of the user. Each display module 104,105 may include an electronic display 106 coupled to an imaging component 108 for conveying images generated by the electronic display 106 to left 174 and right 175 eyeboxes where the user's eye is to be placed for viewing the images. Herein, the term “eyebox” means a three-dimensional geometrical area where images of acceptable quality may be presented to the user's eye. The imaging component 108 may be a lens, a mirror, or any other element having optical (i.e. focusing) power. The lens may include e.g. a refractive lens, a Fresnel lens, a diffractive lens, an active or passive Pancharatnam-Berry phase (PBP) lens, a liquid lens, a liquid crystal lens, etc.

Each display module 104,105 may include an eye-tracking system for tracking position and orientation of the user's eye. The eye-tracking system may include an array of illuminators 110 for illuminating the user's eye, typically with invisible light such as infrared light, a hot mirror 112 for reflecting the infrared light scattered by the user's eye and eye region of the face, while transmitting visible light from the electronic display 106, and a camera 114 for detecting an image of the eye with the pupil and reflections, so-called “glints”, of the illuminators 110 from the eye, for determining eye position and orientation. Herein, the term “eye region” denotes the area of the face including the eyes, and may include the eye brows, the nose bridge, the outer canthus of both eyes, and down to the check bone under both eyes. The eye region includes the eye itself and of particular interest to gaze tracking are the cornea, the iris, and the pupil. The eye tracking system may be configured to operate with an acceptable level of precision and fidelity of eye position and gaze angle determination within the entire eyeboxes 174,175.

A processing module 120 may be coupled to the electronic displays 106, the illuminators 110, and the cameras 114. During normal operation of the wearable display system 100, the processing module 120 generates images to be displayed by the electronic displays 106 of both display modules 104,105, energizes the illuminators 110, obtains images of the eye regions from the corresponding cameras 114, and determines use's gaze direction and convergence angle of the user's eyes from the eye pupils positions and glints positions in the obtained images. The processing module 120 may be internal to the headset body 102 as shown, or it may be external. A sensor other than an eye-tracking camera may also be used to determine current eye position and orientation. For example, an ultrasound sensor or a 3D scanner for scanning the eye area or entire face of the user may be used for this purpose.

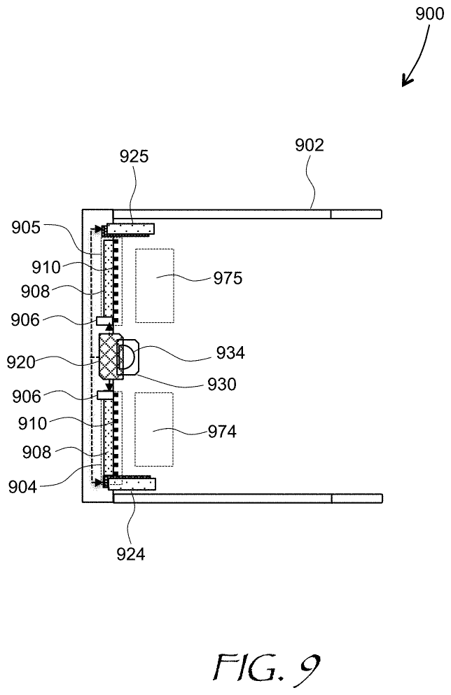

The wearable display system 100 of FIG. 1 is only an example of an artificial reality (AR)/virtual reality (VR) headset configuration. In some configurations, a single display unit may provide images to both eyes, sequentially or simultaneously. In some configurations, the imaging components 108 may be absent, and pupil-replicating waveguides may be used to carry images in angular domain generated by miniature projector(s) directly to the user's eyes. The latter embodiment is considered in more detail further below with reference to FIG. 9. In some configurations, the cameras 114 may be not part of an eye tracking system but used for some other purposes, e.g. imaging of a dedicated part of user's face such as an eye region, 3D imaging of the entire user's face, sensing distances to the eyes (eye relief), distances to the forehead, etc. The wearable display system 100 may include a dedicated proximity sensor to determine when the wearable display system 100 is worn by a user, and/or to determine distances between facial features and the wearable display system 100 when worn by the user. All these configurations may benefit from the headset adjustment for optimal viewing by the user as disclosed herein.

The processing module 120 may be configured to provide guidance to the user for adjusting the headset on the user's head. To that end, the processing module 120 may be configured to use the cameras 114 to determine an offset of current eye positions of the user wearing the headset body 102 relative to optimal positions of the eyes in the eyeboxes 174,175. The eyeboxes 174,175 positions relative to the position of the eyes depend on the headset position on the user's head, as well as on the position of the respective display modules 104,105 within the headset body 102. Herein, the term “optimal eye position” means a position which provide acceptable image quality, wide field of view, and/or low image artifacts when the eye is placed in the optimal position. Furthermore, the optimal eye position is within an optimal range of the eye tracking system for reliably determining eye position and orientation (gaze direction). In some embodiments, the optimal eye position is in the geometrical center of each eyebox 174,175 of the headset.

The processing module 120 may be configured to determine a direction of adjustment of the headset body 102 to lessen the offset, and provide a corresponding instruction to the user to perform the headset adjustment in the determined direction. The direction of the headset adjustment may be any combination of up-down, sideways i.e. left-right, tilt/roll, and also closer or farther away from the user's face. The distance between the left 104 and right 105 display modules 104, or between the generated images for each eye in case of a single display module generating both such images, may be adjusted to match the inter-pupil distance (IPD) of a specific user. The goal is to place each eye of the user at an optimal viewing position relative to the corresponding display modules 104,105. The processing module 120 may display visual cues to the user on the electronic displays 106, e.g. help screens instructing the user to perform the adjustments in the determined directions for manual adjustment of the headset body 102 by the user to lessen the offsets.

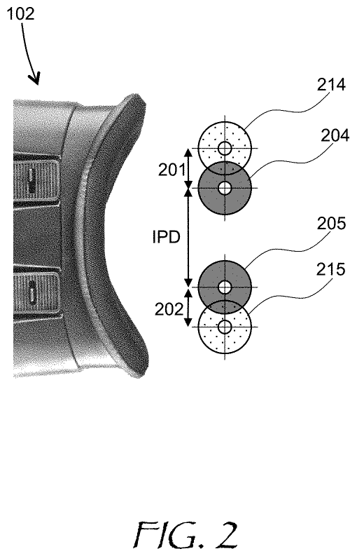

In some embodiments, the visual cues for the headset adjustment may include target images showing positions of both eyes relative to optimal positions. For example, referring to FIG. 2 with further reference to FIG. 1, the displayed images include generated target positions 204,205 (FIG. 2), which correspond to the positions and the IPD of the eyes of the current user, and generated current eyebox positions 214, 215 separated from the target positions 204,205 by respective offsets 201,202. The user adjusts the headset body 102 position and the distance between the display modules 104,105 (FIG. 1) to reduce the offsets 201,202 by matching the first current eyebox position 214 to the corresponding first target position 204, and by matching the second current eyebox position 215 to the corresponding second target position 205. In some embodiments, the display modules 104,105 may be placed on translation stages which can be moved by a user e.g. by turning a dial located on the headset while looking at the electronic displays 106. The user may turn the dial until the distance between the current eyebox positions 214,215 matches the distance between the target positions 204,205. Then, the user may adjust the headset left to right to superimpose both current positions 214, 215 with the corresponding target positions 204, 205, ideally reducing the offsets 201,202 to zero. This order of adjustment may be reversed, i.e. the left-to-right adjustment may be done first. Both adjustments may also be done iteratively, in turns.

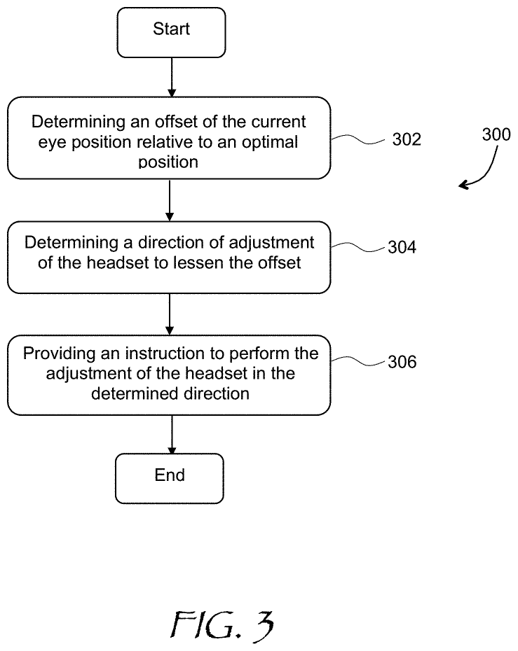

Referring to FIG. 3 with further reference to FIGS. 1 and 2, a method 300 for adjusting a headset, e.g. the headset of FIG. 1, includes using a sensor, e.g. the camera 114, to determine (302) an offset of a current eye position of the user wearing the headset relative to an optimal eye position in an eyebox of the headset, e.g. the offset 201 and/or 202 (FIG. 2). The offset can be determined by detecting the eye position by the cameras 114 (FIG. 1), and comparing the detected eye positions with current eyebox 174,175 positions. Since the cameras 114 are affixed within the corresponding display modules 104,105, the eye position as detected by the cameras 114 is indicative of relative position of the eyes and the corresponding display modules 104,105 and their respective eyeboxes 174,175. In some configurations, a sensor or sensors that detect the eye positions may be fixed relative to the headset body 102. This sensor may perform other functions, or in some cases may be a dedicated sensor for determining facial features of the current user, such as the eye position, the eye recess relative to the forehead, etc. In some embodiments, the sensor may include a three-dimensional (3D) scanner of the user's eye region or the entire face. When the camera or the 3D scanner is fixed in the headset body 102, an indication of position of display modules 104,105 relative to the headset body 102, or relative to each other, needs to be provided. For this, the display modules 104,105 may be provided with encoders determining their positions, or in some embodiments, the display modules 104,105 may be placed on translation stages equipped with stepper motors or other types of motors, which provide a controllable degree of movement upon energizing with a certain number of pulses. The pulse count may indicate the position of the display modules 104,105 relative to the headset body 102. These and other embodiments will be described further below.

The method 300 may further include determining (304) a direction of adjustment of the headset to lessen the offset. This step may include determining optimal positions of the corresponding display modules 104 and 105, and computing a difference, e.g. a vector difference, between the optimal and actual positions of the display modules 104 and 105. Then, an instruction may be provided (306) to perform the adjustment of the headset in the determined direction. The instruction may include cues to the user e.g. in form of the targets 204,205 (FIG. 2) displayed by the electronic displays 106, and/or commands or control signals to motorized stages of the display modules, if such motorized stages are provided in a display system.

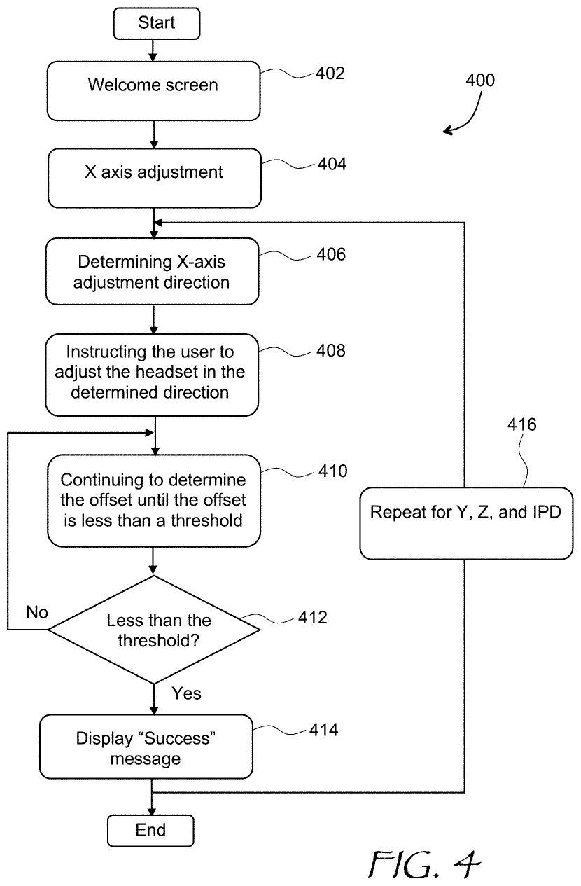

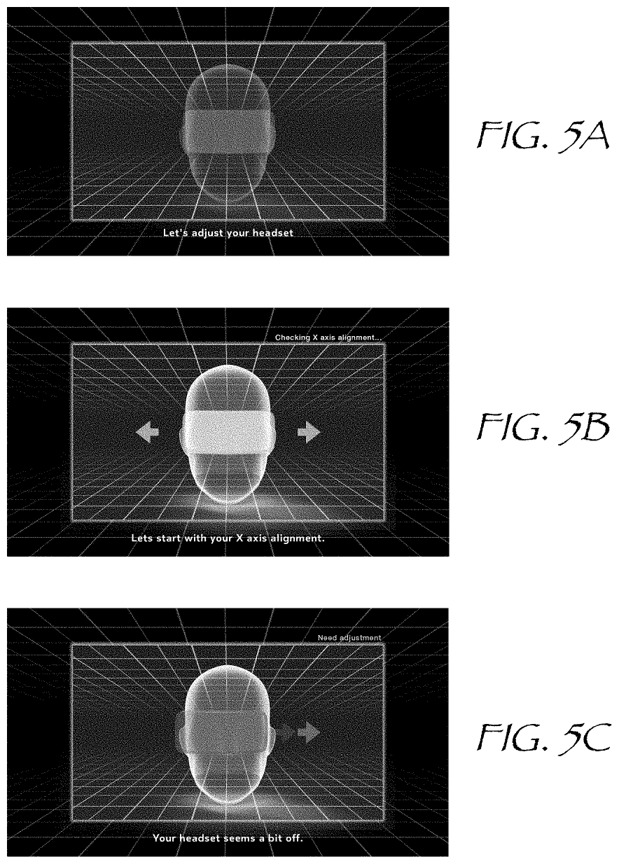

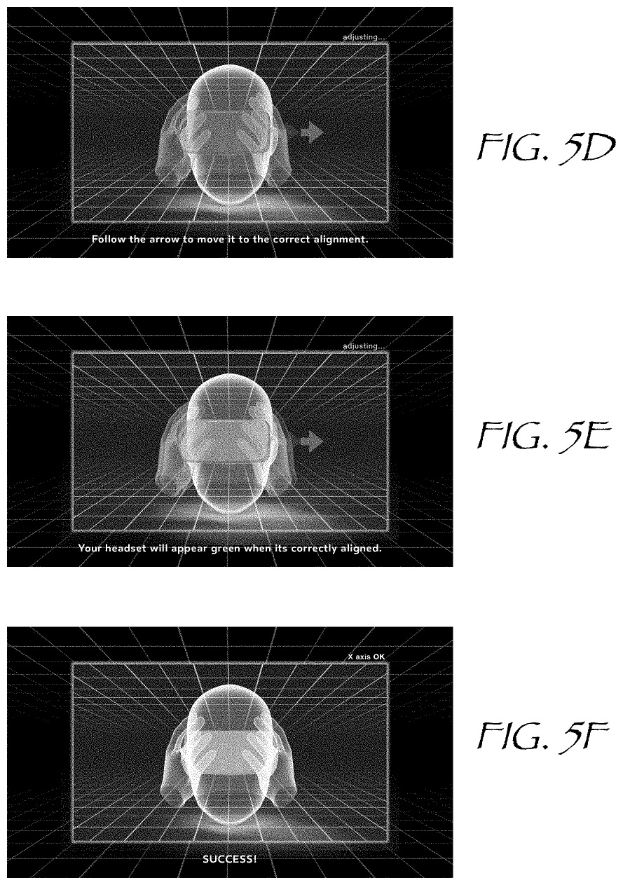

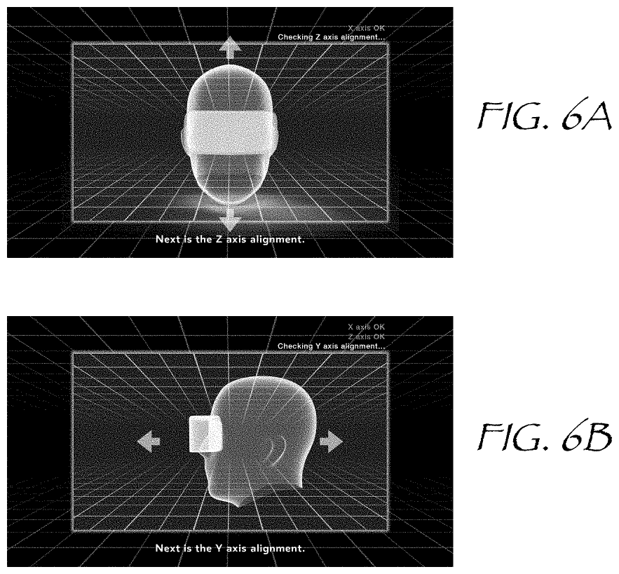

In some embodiments, the user may be presented with a set of instructional screens guiding the user from one adjustment step to another. By way of a non-limiting illustrative example, referring to FIG. 4 and FIGS. 5A to 5F, a method 400 (FIG. 4) for headset adjustment may begin with a user being presented (402) with a welcome screen (FIG. 5A). The adjustment may start e.g. with X axis adjustment (404), and the user may be presented with a corresponding message and graphics (FIG. 5B). In this example, the X axis is a horizontal left-right axis, and the headset is adjusted for an optimal left-right position. Then, the processing module 120 determines (406; FIG. 4) the required direction of the X axis adjustment, and the user is instructed (408) to adjust the headset body 102 in the determined direction by presenting corresponding screens (FIGS. 5C and 5D). The processing module 120 continues to determine the offset in real time (410) as the user adjusts the headset body 102 along the X axis, while checking (412) if the measured offset is less than a threshold beyond which the headset body 102 is considered to be aligned along X axis. The processing module 120 displays a corresponding message (FIG. 5E) on the electronic displays 106. Once the measured offset is less than the threshold, the processing module 120 displays (414) a “Success!” screen (FIG. 5F). The process may repeat (416) for Z axis (that is, vertical axis; FIG. 6A) and for Y axis (that is, the direction of the eye relief; FIG. 6B). In some embodiments, the process may also include tilt adjustment guidance, including clocking or roll angle of rotation about Y axis (i.e. about a straight direction of sight, FIG. 6B) and/or a pitch angle of rotation about X axis (up/down, FIG. 5B). Ideally, the headset body 102 is level w.r.t. the eyes, i.e. horizontal when the eyes are horizontal (roll angle adjustment), and does not look up or down when the head is level (pitch angle adjustment).

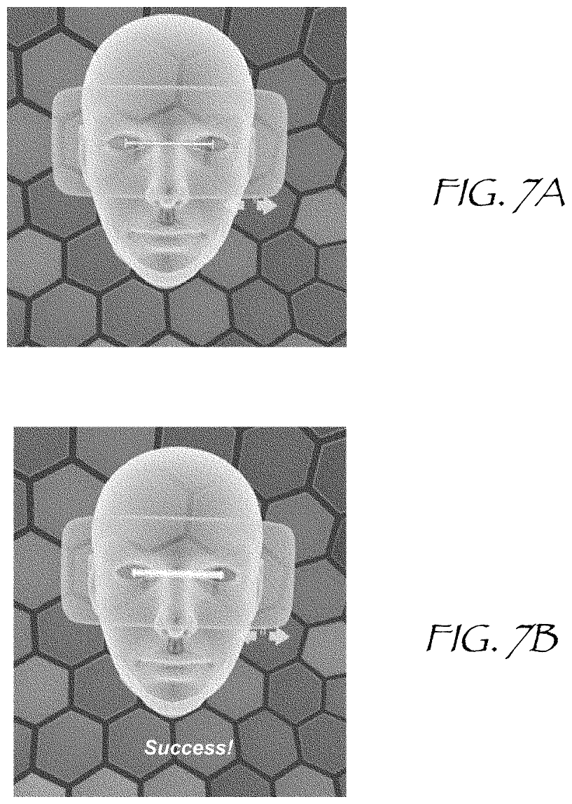

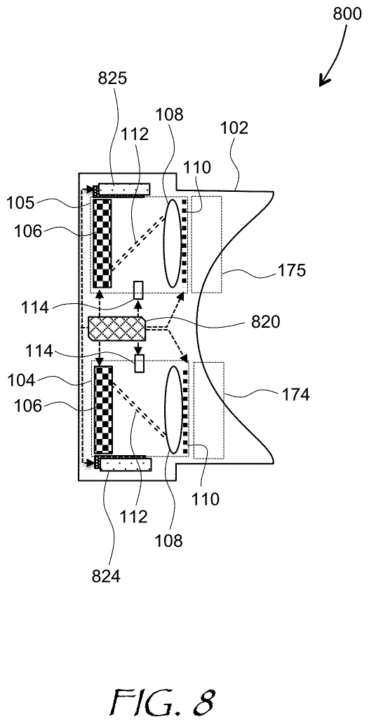

The distance between the left 104 and right 105 display modules may be adjusted to correspond to the IPD of the user. The processing module 120 may determine a required direction of adjustment and display it to the user (FIG. 7A). The user then proceeds to adjust the headset e.g. by adjusting the distance between the display modules 104,105. Furthermore in some embodiments, the imaging components 108 may be made manually adjustable to provide the accommodation/prescription correction per eye during the headset setup to get an ideal setup for the use. The imaging components 108 may also be automatically adjusted. Based on measuring the virtual depth plane from the gaze information, it is possible to determine the vergence/accommodation mismatch for the current user and correct it automatically. Once the processing module 120 determines that user has adjusted the headset, a corresponding success screen may be displayed (FIG. 7B). The process of X, Y, Z axis headset adjustment, tilt adjustment, and the IPD adjustment may be performed in any order.

The methods 300 of FIGS. 3 and 400 of FIG. 4 may be implemented in software. A non-transitory memory may be used to store instructions which, when executed by a processor, cause the processor to perform the steps of the method 300. The processor can be, for example, a general-purpose processor or a microprocessor suitable for implementation within a portable electronic device. The memory may be volatile, such as static random access memory (SRAM) and/or dynamic random access memory (DRAM) and/or non-volatile, such as read-only memory (ROM), flash memory, and the like. Furthermore, the memory 1220 may include removable storage devices, such as secure digital (SD) cards.

Referring now to FIG. 8, a wearable display system 800 is similar to the wearable display system 100 of FIG. 1. The wearable display system 800 of FIG. 8 further includes a left motorized stage 824 supporting the left display module 104 in the headset body 102, and a right motorized stage 825 supporting the right display module 105 in the headset body 102. A processing module 820 is coupled to the electronic displays 106, the illuminators 110, the cameras 114, and the motorized stages 824,825. During normal operation of the wearable display system 100, the processing module 820 generates images to be displayed by the electronic displays 106 of both display modules 104,105, energizes the illuminators 110, obtains images of eye regions from the corresponding cameras 114, and determines use's gaze direction and convergence angle of the user's eyes from the eye pupils positions and glints positions in the obtained images.

During an initial setup of the wearable display system 800, the processing module 820 may use the cameras 114 to determine an offset of a current position of eyes of the user wearing the headset relative to an optimal eye position in the eyeboxes 174,175. Based on the determined offset, the processing module 820 may determine a direction of adjustment of the headset to lessen the offset. The processing module 820 may then translate the display modules 104,105 by providing commands to the respective motorized stages 824,825 to lessen the offset. The processing module 820 may be disposed in the headset body 802 as shown, or may be a part of an external controller or console, as in so-called “tethered” wearable display systems. An external processing module may also be used in wirelessly connected wearable display systems. The process of adjustment may be automatic, and may be performed in an inconspicuous manner, such that the user is not even aware that the adjustment of the wearable display system 800 takes place.

In some embodiments, the motorized stages 824,825 include translation stages. In some embodiments, the motorized stages 824,825 include rotary stages for adjusting pointing angles of the display modules 104,105. Furthermore, the motorized stages 824,825 may be coupled to specific components of the display modules 104,105, for example to the electronic displays 106 or the imaging components 108, and configured for displacement, rotation, or both displacement and rotation of these specific components relative to the display modules 104,105 to shift the eyeboxes 174,175 as required to reduce the offset. The display modules 104,105 may be movable by the motorized stages 824,825 in X, Z to adjust lateral position and IPD, and/or in Y to adjust the eye relief distance. Furthermore, as mentioned above, a single display module may be provided for displaying images to both eyes of the user. A single motorized stage may be used to perform all required adjustments.

Turning to FIG. 9, a wearable display system 900 includes a headset body 902 having a form factor of a pair of eyeglasses, and left 904 and right 905 display modules supported by the headset body 902. The left display module 904 is configured to present an image to the left eye of a user in an eyebox 974, and the right display module 905 is configured to present an image to the right eye of the user in an eyebox 975. Each display module 904,905 may include an electronic display e.g. a miniature projector 906. The miniature projector 906 is coupled to a pupil-replicating waveguide 908 configured for conveying images in angular domain generated by the projector 906 to the eyeboxes 974,975.

The wearable display system 900 may include a scanner 930 for scanning the user's face. The scanner 930 may include a sensor 934, e.g. an eye camera, for obtaining images of an eye area of the face when the face is illuminated with illuminators 910 disposed on the inner surfaces of the pupil-replicating waveguides 908. More cameras can be provided for obtaining images of different parts of the user's face, such as mouth cameras, glabella/nose cameras, lower temporal area cameras, etc. The sensor 934 may be used for determining eye position parameters such as IPD, eye recess relative to the forehead level, and the like. In some embodiments, a depth sensor on the head-mounted display (HMD) of the current user or HMDs of other users may be employed to perform the face scan of the current user. In some embodiments, world tracking cameras used by the HMD of the current user or HMDs of other users, also termed “inside out tracking” (JOT) cameras, may be used to perform the face scan of the current user. The IOT cameras may be used in mono or stereo mode.

The wearable display system 900 of FIG. 9 may further include a left motorized stage 924 supporting the left display module 904, and a right motorized stage 925 supporting the right display module 905. A processing module 920 may be coupled to the projectors 906, the motorized stages 924,925, and the sensor 934, and to other cameras, if any. During normal operation of the wearable display system 900, the processing module 920 generates images to be displayed by the projectors 906 of both display modules 904,905, energizes the illuminators 910, obtains images of the eye regions, and determines user's gaze direction and convergence angle of the user's eyes from the eye pupils positions and glints positions in the obtained images.

During initial setup of the wearable display system 900, the processing module 920 may use the sensor 934 to determine an offset of eyes position of the user wearing the headset relative to an optimal eyes positions in the eyeboxes 974,975. Based on the determined offset, the processing module 920 may determine a direction of adjustment of the headset to lessen the offset. The processing module 920 may then translate and/or rotate the display modules 904,905 using the respective motorized stages 924,925 to lessen the offset. The lateral position of the eyeboxes 974,975, pitch and roll angles, and/or the eye relief distances may be adjusted in this manner. This process may be automatic, and may be performed in an inconspicuous manner, such that the user is not even aware that the adjustment of the headset takes place based on the user's specific IPD and other facial features.

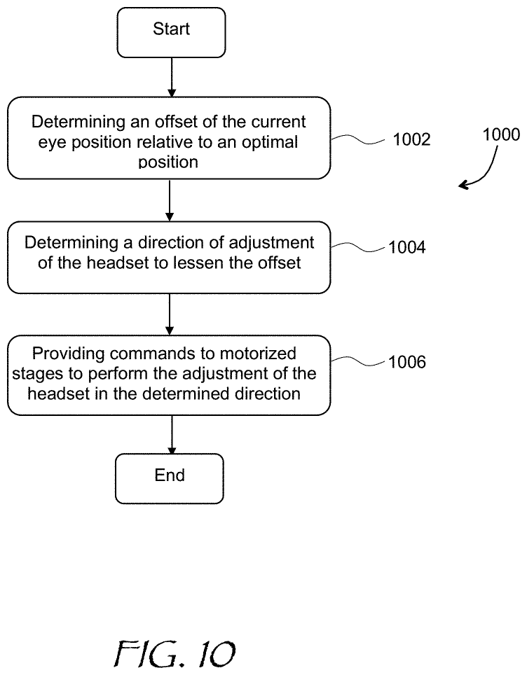

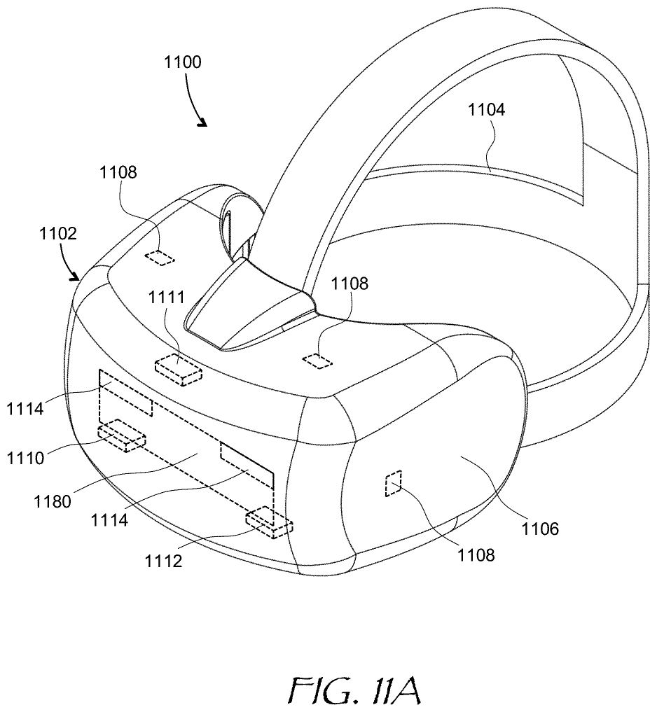

Referring now to FIG. 10 with further reference to FIGS. 8 and 9, a method 1000 for adjusting a headset of a wearable display system, e.g. the wearable display system 800 of FIG. 8 or the wearable display system 900 of FIG. 9, includes using at least one sensor, e.g. the cameras 114 of the wearable display system 800, or the sensor 934 of the wearable display system 900, and/or a proximity sensor, to determine (1002) an offset of a current eye position of the user wearing the headset relative to an optimal eye position in an eyebox of the headset. This determination may be performed for each eye, e.g. the offset of the left eye of the user relative to the left eyebox 974, and offset of the right eye of the user relative to the right eyebox 975. The offset(s) can be determined by detecting the eye position by the cameras 114 or 934, and comparing the detected eye positions with current eyebox positions. The offset determination process may be dependent on the headset construction. For example, in the wearable display system 800 of FIG. 8, the cameras 114 are affixed within the corresponding display modules 104,105, and the eye position as detected by the cameras 114 is indicative of relative position of the eyes and the corresponding display modules 104,105 and their respective eyeboxes 174,175. In the wearable display system 900 of FIG. 9, the sensor 934 that detects the eye positions is fixed relative to the headset body 902. This camera is a part of the 3D scanner 930. Accordingly, indications of positions of the display modules 904,905 relative to the headset body 902, or relative to each other, need to be provided. For this, the display modules 904,905 may be provided with encoders determining their positions, or in some embodiments, the display modules 904,905 may be placed on translation and/or rotary stages equipped with stepper motors or other types of motors, which provide a controllable degree of linear and/or angular movement upon energizing with a certain number of pulses. The pulse count may indicate the position of the display modules 904,905.

The method 1000 may further include determining (1004) a direction of adjustment of the headset to lessen the offset. This step may include determining optimal position and/or orientation of the corresponding display modules, and computing a difference, e.g. a vector difference, between the optimal and actual positions/orientations of the display modules. Then, a command (a control signal) may be provided (1006) to the corresponding motorized stages, e.g. the motorized stages 824 and 825 of the wearable display system 800 of FIG. 8, or the motorized stages 924 and 925 of the wearable display system 900 of FIG. 9, to perform the adjustment of the headset in the determined direction.

The adjustment may include a translation of at least a portion of the display modules 104,105 or 904,905, a reorientation of at least a portion of the display modules 104,105 or 904,905, or both. Entire display modules 104,105 or 904,905 may be translated or rotated (reoriented), or specific components may be moved or rotated within the respective modules, depending on a particular implementation. Depending on the implementation, the instructions by the processing modules 820 or 920 to perform the adjustment may include commands to the respective motorized stages to translate, reorient, or both translate and reorient at least a portion of corresponding display modules 104,105 or 904,905 to lessen the offset determined at 1004. The focusing by display components, e.g. the projectors 906 of the wearable display system 900 of FIG. 9 or the imaging components 108 of the wearable display system 800 of FIG. 8, may be automatically adjusted to provide the accommodation/prescription correction per eye during the headset setup. Furthermore in some embodiments, the established positions and/or orientations of the eyeboxes 174,175 (FIG. 1); 874,875 (FIG. 8), or 974,975 (FIG. 9) relative to the user's eyes may be used to compute a change of the displayed static content position and/or a change of a distortion map based on the users eye position to further improve the viewing comfort after the adjustment.

The method 1000 may be implemented in software. A non-transitory memory may be used to store instructions which, when executed by a processor, cause the processor to perform the steps of the method 1000. The processor can be, for example, a general-purpose processor or a microprocessor suitable for implementation within a portable electronic device. The memory may be volatile, such as static random access memory (SRAM) and/or dynamic random access memory (DRAM) and/or non-volatile, such as read-only memory (ROM), flash memory, and the like. Furthermore, the memory 1220 may include removable storage devices, such as secure digital (SD) cards.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

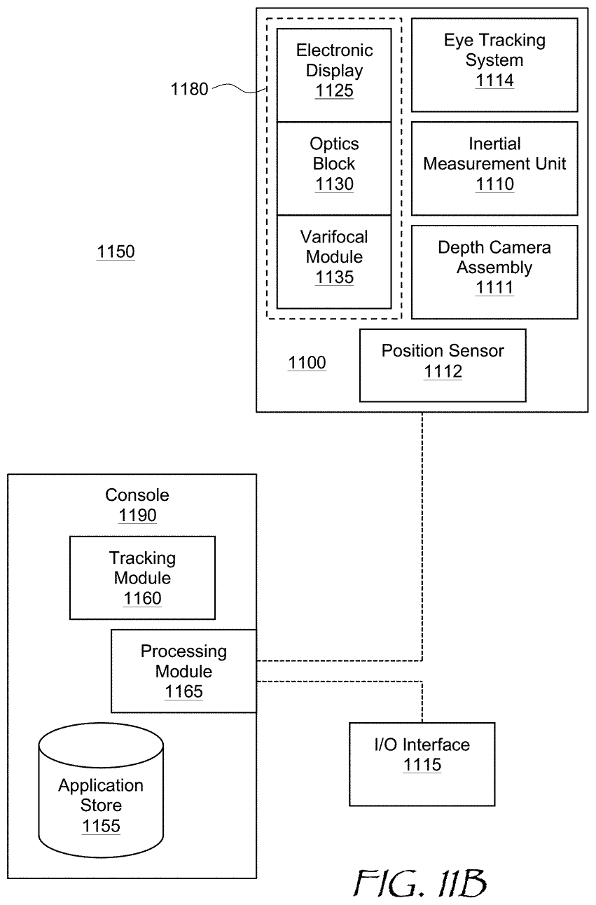

Referring to FIG. 11A, an HMD 1100 is an example of an AR/VR wearable display system which encloses the user's face, for a greater degree of immersion into the AR/VR environment. The HMD 1100 is an embodiment of the wearable display system 100 of FIG. 1 or the wearable display system 800 of FIG. 8, for example. The function of the HMD 1100 is to augment views of a physical, real-world environment with computer-generated imagery, and/or to generate the entirely virtual 3D imagery. The HMD 1100 may include a front body 1102 and a band 1104. The front body 1102 is configured for placement in front of eyes of a user in a reliable and comfortable manner, and the band 1104 may be stretched to secure the front body 1102 on the user's head. A display system 1180 may be disposed in the front body 1102 for presenting AR/VR imagery to the user. Sides 1106 of the front body 1102 may be opaque or transparent.

In some embodiments, the front body 1102 includes locators 1108 and an inertial measurement unit (IMU) 1110 for tracking acceleration of the HMD 1100, and position sensors 1112 for tracking position of the HMD 1100. The IMU 1110 is an electronic device that generates data indicating a position of the HMD 1100 based on measurement signals received from one or more of position sensors 1112, which generate one or more measurement signals in response to motion of the HMD 1100. Examples of position sensors 1112 include: one or more accelerometers, one or more gyroscopes, one or more magnetometers, another suitable type of sensor that detects motion, a type of sensor used for error correction of the IMU 1110, or some combination thereof. The position sensors 1112 may be located external to the IMU 1110, internal to the IMU 1110, or some combination thereof.

The locators 1108 are traced by an external imaging device of a virtual reality system, such that the virtual reality system can track the location and orientation of the entire HMD 1100. Information generated by the IMU 1110 and the position sensors 1112 may be compared with the position and orientation obtained by tracking the locators 1108, for improved tracking accuracy of position and orientation of the HMD 1100. Accurate position and orientation is important for presenting appropriate virtual scenery to the user as the latter moves and turns in 3D space.

The HMD 1100 may further include a depth camera assembly (DCA) 1111, which captures data describing depth information of a local area surrounding some or all of the HMD 1100. In some embodiments, the DCA 1111 may include a laser radar (LIDAR), or a similar device. The depth information may be compared with the information from the IMU 1110, for better accuracy of determination of position and orientation of the HMD 1100 in 3D space.

The HMD 1100 may further include an eye tracking system 1114 for determining orientation and position of user's eyes in real time. The determined position of the user's eyes allows the HMD 1100 to perform the (self-) adjustment procedures described above. The obtained position and orientation of the eyes also allows the HMD 1100 to determine the gaze direction of the user and to adjust the image generated by the display system 1180 accordingly. In one embodiment, the vergence, that is, the convergence angle of the user's eyes gaze, is determined. The determined gaze direction and vergence angle may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

Referring to FIG. 11B, an AR/VR system 1150 is an example implementation of the wearable display system 100 of FIG. 1, the wearable display system 800 of FIG. 8, or the wearable display system 900 of FIG. 9. The AR/VR system 1150 includes the HMD 1100 of FIG. 11A, an external console 1190 storing various AR/VR applications, setup and calibration procedures, 3D videos, etc., and an input/output (I/O) interface 1115 for operating the console 1190 and/or interacting with the AR/VR environment. The HMD 1100 may be “tethered” to the console 1190 with a physical cable, or connected to the console 1190 via a wireless communication link such as Bluetooth®, Wi-Fi, etc. There may be multiple HMDs 1100, each having an associated I/O interface 1115, with each HMD 1100 and I/O interface(s) 1115 communicating with the console 1190. In alternative configurations, different and/or additional components may be included in the AR/VR system 1150. Additionally, functionality described in conjunction with one or more of the components shown in FIGS. 11A and 11B may be distributed among the components in a different manner than described in conjunction with FIGS. 11A and 11B in some embodiments. For example, some or all of the functionality of the console 1115 may be provided by the HMD 1100, and vice versa. The HMD 1100 may be provided with a processing module capable of achieving such functionality.

As described above with reference to FIG. 11A, the HMD 1100 may include the eye tracking system 1114 (FIG. 11B) for tracking eye position and orientation, determining gaze angle and convergence angle, etc., the IMU 1110 for determining position and orientation of the HMD 1100 in 3D space, the DCA 1111 for capturing the outside environment, the position sensor 1112 for independently determining the position of the HMD 1100, and the display system 1180 for displaying AR/VR content to the user. The display system 1180 includes (FIG. 11B) an electronic display 1125, for example and without limitation, a liquid crystal display (LCD), an organic light emitting display (OLED), an inorganic light emitting display (ILED), an active-matrix organic light-emitting diode (AMOLED) display, a transparent organic light emitting diode (TOLED) display, a projector, or a combination thereof. The display system 1180 further includes an optics block 1130, whose function is to convey the images generated by the electronic display 1125 to the user's eye. The optics block may include various lenses, e.g. a refractive lens, a Fresnel lens, a diffractive lens, an active or passive Pancharatnam-Berry phase (PBP) lens, a liquid lens, a liquid crystal lens, etc., a pupil-replicating waveguide, grating structures, coatings, etc. The display system 1180 may further include a varifocal module 1135, which may be a part of the optics block 1130. The function of the varifocal module 1135 is to adjust the focus of the optics block 1130 e.g. to compensate for vergence-accommodation conflict, to correct for vision defects of a particular user, to offset aberrations of the optics block 1130, etc.

The I/O interface 1115 is a device that allows a user to send action requests and receive responses from the console 1190. An action request is a request to perform a particular action. For example, an action request may be an instruction to start or end capture of image or video data or an instruction to perform a particular action within an application. The I/O interface 1115 may include one or more input devices, such as a keyboard, a mouse, a game controller, or any other suitable device for receiving action requests and communicating the action requests to the console 1190. An action request received by the I/O interface 1115 is communicated to the console 1190, which performs an action corresponding to the action request. In some embodiments, the I/O interface 1115 includes an IMU that captures calibration data indicating an estimated position of the I/O interface 1115 relative to an initial position of the I/O interface 1115. In some embodiments, the I/O interface 1115 may provide haptic feedback to the user in accordance with instructions received from the console 1190. For example, haptic feedback can be provided when an action request is received, or the console 1190 communicates instructions to the I/O interface 1115 causing the I/O interface 1115 to generate haptic feedback when the console 1190 performs an action.

The console 1190 may provide content to the HMD 1100 for processing in accordance with information received from one or more of: the IMU 1110, the DCA 1111, the eye tracking system 1114, and the I/O interface 1115. In the example shown in FIG. 11B, the console 1190 includes an application store 1155, a tracking module 1160, and a processing module 1165. Some embodiments of the console 1190 may have different modules or components than those described in conjunction with FIG. 11B. Similarly, the functions further described below may be distributed among components of the console 1190 in a different manner than described in conjunction with FIGS. 11A and 11B.

The application store 1155 may store one or more applications for execution by the console 1190. An application is a group of instructions that, when executed by a processor, generates content for presentation to the user. Content generated by an application may be in response to inputs received from the user via movement of the HMD 1100 or the I/O interface 1115. Examples of applications include: gaming applications, presentation and conferencing applications, video playback applications, or other suitable applications.

The tracking module 1160 may track movements of the HMD 1100 or of the I/O interface 1115, the IMU 1110, or some combination thereof. The tracking module 1160 may also calibrate the AR/VR system 1150 using one or more calibration parameters and may adjust one or more calibration parameters to reduce error in determination of the position of the HMD 1100 or the I/O interface 1115. Calibration performed by the tracking module 1160 also accounts for information received from the IMU 1110 in the HMD 1100 and/or an IMU included in the I/O interface 1115, if any. Additionally, if tracking of the HMD 1100 is lost, the tracking module 1160 may re-calibrate some or all of the AR/VR system 1150.

The processing module 1165 executes applications within the AR/VR system 1150 and receives position information, acceleration information, velocity information, predicted future positions, or some combination thereof, of the HMD 1100 from the tracking module 1160. Based on the received information, the processing module 1165 determines content to provide to the HMD 1100 for presentation to the user. Additionally, the processing module 1165 performs an action within an application executing on the console 1190 in response to an action request received from the I/O interface 1115 and provides feedback to the user that the action was performed. The provided feedback may be visual or audible feedback via the HMD 1100 or haptic feedback via the I/O interface 1115.

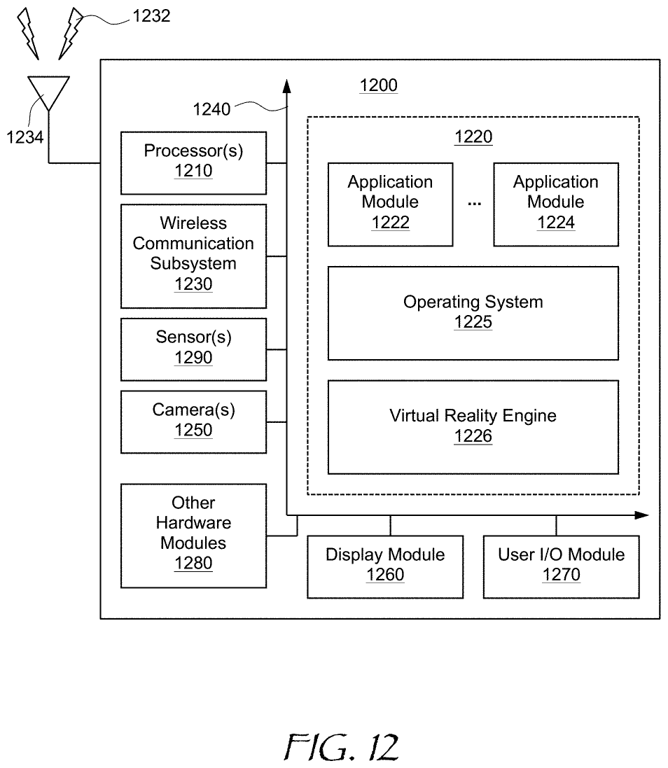

Referring to FIG. 12, a simplified block diagram of an example electronic system 1200 is an example of a wearable display system for implementing some of the embodiments disclosed herein. The electronic system 1200 may be used as an electronic system of the HMDs and the near-eye displays described above. The electronic system 1200 may include one or more processors 1210 and a memory 1220. Processor(s) 1210 may be configured to execute instructions for performing operations and methods disclosed herein and can be, for example, a general-purpose processor or a microprocessor suitable for implementation within a portable electronic device. Processor(s) 1210 may be communicatively coupled to a plurality of components within the electronic system 1200. To implement this communicative coupling, the processor(s) 1210 may communicate with other illustrated components across a bus 1240. The bus 1240 may be any subsystem adapted to transfer data within electronic system 1200. The bus 1240 may include a plurality of computer buses and additional circuitry to transfer data.

The memory 1220 may be operably coupled to the processor(s) 1210. In some embodiments, the memory 1220 may be configured for short-term and/or long-term storage, and may be divided into several units. The memory 1220 may be volatile, such as static random access memory (SRAM) and/or dynamic random access memory (DRAM) and/or non-volatile, such as read-only memory (ROM), flash memory, and the like. Furthermore, the memory 1220 may include removable storage devices, such as secure digital (SD) cards. The memory 1220 may provide storage of computer-readable instructions, data structures, program modules, and other data for the electronic system 1200. In some embodiments, the memory 1220 may be distributed in different hardware modules. A set of instructions and/or code might be stored on the memory 1220. The instructions might take the form of executable code that may be executable by the electronic system 1200, and/or might take the form of source and/or installable code, which, upon compilation and/or installation on the electronic system 1200 (e.g., using any of a variety of generally available compilers, installation programs, compression/decompression utilities, etc.), may take the form of executable code.

In some embodiments, the memory 1220 may store a plurality of application modules 1222 to 1224, which may include any number of applications. Examples of applications may include gaming applications, presentation or conferencing applications, video playback applications, or other suitable applications. The applications may include a depth sensing function and/or an eye tracking function. The application modules 1222 to 1224 may include particular instructions to be executed by processor(s) 1210. In some embodiments, certain applications or parts of the application modules 1222 to 1224 may be executable by other hardware modules 1280. In certain embodiments, the memory 1220 may additionally include secure memory, which may include additional security controls to prevent copying or other unauthorized access to secure information.

In some embodiments, the memory 1220 may include an operating system 1225 loaded therein. The operating system 1225 may be operable to initiate the execution of the instructions provided by the application modules 1222 to 1224 and/or manage the other hardware modules 1280, as well as interfaces with a wireless communication subsystem 1230, which may include one or more wireless transceivers. The operating system 1225 may be adapted to perform other operations across the components of the electronic system 1200 including threading, resource management, data storage control, and other similar functionality.

The wireless communication subsystem 1230 may include, for example, an infrared communication device, a wireless communication device and/or a chipset (such as a Bluetooth® device, an IEEE 802.11 device, a Wi-Fi device, a WiMax device, cellular communication facilities, etc.), and/or similar communication interfaces. The electronic system 1200 may include one or more antennas 1234 for wireless communication as part of the wireless communication subsystem 1230 or as a separate component coupled to any portion of the electronic system 1200. Depending on the desired functionality, the wireless communication subsystem 1230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. The wireless communications subsystem 1230 may permit data to be exchanged with a network, other computer systems, and/or any other devices described herein. The wireless communication subsystem 1230 may include a means for transmitting or receiving data, such as identifiers of HMD devices, position data, a geographic map, a heat map, photos, or videos, using the antenna(s) 1234 and wireless link(s) 1232. The wireless communication subsystem 1230, the processor(s) 1210, and the memory 1220 may together comprise at least a part of one or more of a means for performing some functions disclosed herein.

In some embodiments, the electronic system 1200 includes one or more sensors 1290. The sensor(s) 1290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, the sensor(s) 1290 may include one or more inertial measurement units (IMUS) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

The electronic system 1200 may further include a display module 1260. The display module 1260 may be a near-eye display, and may graphically present information such as images, videos, and various instructions, from the electronic system 1200 to a user. Such information may be derived from one or more of the application modules 1222 to 1224, a virtual reality engine 1226, the one or more other hardware modules 1280, a combination thereof, or any other suitable means for resolving graphical content for the user (e.g., by the operating system 1225). The display module 1260 may include a liquid crystal display (LCD), a light-emitting diode (LED) array (including, for example, OLED, ILED, mLED, AMOLED, TOLED, etc.), light emitting polymer display (LPD), or some other display technology.

The electronic system 1200 may further include a user input/output module 1270 allowing a user to send action requests to the electronic system 1200. An action request may be a request to perform a particular action. For example, an action request may be to start or end an application or to perform a particular action within the application. The user input/output module 1270 may include one or more input devices. In some embodiments, the user input/output module 1270 may provide haptic feedback to the user in accordance with instructions received from the electronic system 1200. For example, haptic feedback may be provided when an action request is received or has been performed.

The electronic system 1200 may include a camera 1250 that may be used to take photos or videos of a user, for example, for tracking the user's eye position, or for initial setup of the headsets as described herein. The camera 1250 may also be used to take photos or videos of the environment, for example, for VR, AR, or MR applications. The camera 1250 may include, for example, a complementary metal-oxide-semiconductor (CMOS) image sensor, e.g. a silicon sensor, with a few millions or tens of millions of pixels. In some implementations, the camera 1250 may include two or more cameras that may be used to capture 3D images.

In some embodiments, the electronic system 1200 may include a plurality of other hardware modules 1280. Each of other the hardware modules 1280 may be a physical module within the electronic system 1200. While each of the other hardware modules 1280 may be permanently configured as a structure, some of other hardware modules 1280 may be temporarily configured to perform specific functions or temporarily activated. Examples of the other hardware modules 1280 may include, for example, an audio output and/or input module (e.g., a microphone or speaker), a near field communication (NFC) module, a rechargeable battery, a battery management system, a wired/wireless battery charging system, etc. In some embodiments, one or more functions of the other hardware modules 1280 may be implemented in software.

In some embodiments, the memory 1220 of the electronic system 1200 may also store the virtual reality engine 1226. The virtual reality engine 1226 may include an executable code of applications within the electronic system 1200. The virtual reality engine 1226 may receive position information, acceleration information, velocity information, predicted future positions, or some combination thereof of the HMD device from the various sensors. In some embodiments, the information received by the virtual reality engine 1226 may be used for producing a signal to the display module 1260. In some implementations, the processor(s) 1210 may include one or more GPUs that may execute the virtual reality engine 1226.

The above-described hardware and modules may be implemented on a single device or on multiple devices that can communicate with one another using wired or wireless connections. For example, in some implementations, some components or modules, such as GPUs, the virtual reality engine 1226, and applications such as, for example, a headset calibration application and/or eye-tracking application, may be implemented on a console separate from the head-mounted display device. In some implementations, one console may be connected to or support more than one wearable display device.

In some implementations, different and/or additional components may be included in the electronic system 1200. Similarly, functionality of one or more of the components can be distributed among the components in a manner different from the manner described above. For example, in some embodiments, the electronic system 1200 may be modified to include other system environments, such as an AR system environment and/or an MR environment.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

What is claimed is:

1. A method for a headset adjustment, the headset comprising a sensor and a display module comprising an electronic display for displaying images to a user, the method comprising:
using the sensor to determine an offset of a current eye position of the user wearing the headset relative to an optimal eye position in an eyebox of the headset;
determining a direction of adjustment of the headset to lessen the offset; and
providing an instruction to perform the adjustment of the headset in the determined direction.

2. The method of claim 1, wherein providing the instruction to perform the adjustment comprises displaying, by the display module, a visual cue to the user for manual adjustment of the headset by the user to lessen the offset.

3. The method of claim 1, wherein providing the instruction to perform the adjustment comprises providing a command to a motorized stage to at least one of translate or reorient at least a portion of the display module of the headset to lessen the offset.

4. The method of claim 3, wherein the command is at least one of to translate or to rotate the display module in the headset.

5. The method of claim 3, wherein the command is at least one of to translate or to rotate an imaging component of the display module.

6. The method of claim 1, wherein the sensor comprises a camera of an eye-tracking system, the method comprising using the eye-tracking system to determine the current eye position.

7. The method of claim 1, wherein the sensor comprises a 3D scanner for scanning a face of the user, the method comprising using the 3D scanner to determine the current eye position.

8. A non-transitory memory having stored thereon instructions which, when executed by a processor, cause the processor to:
use a sensor of a headset comprising a display module comprising an electronic display for displaying images to a user, to determine an offset of a current eye position of the user wearing the headset relative to an optimal eye position in an eyebox of the headset;
determine a direction of adjustment of the headset to lessen the offset; and
provide an instruction to perform the adjustment of the headset in the determined direction.

9. The non-transitory memory of claim 8, wherein providing the instruction to perform the adjustment comprises causing the display module to display a visual cue to the user for manual adjustment of the headset by the user to lessen the offset.

10. The non-transitory memory of claim 8, wherein providing the instruction to perform the adjustment comprises providing a command to a motorized stage to at least one of translate or reorient at least a portion of the display module of the headset to lessen the offset.

11. The non-transitory memory of claim 10, wherein the command is at least one of to translate or to rotate the display module in the headset.

12. The non-transitory memory of claim 10, wherein the command is at least one of to translate or to rotate an imaging component of the display module.

13. The non-transitory memory of claim 8, wherein the sensor comprises a camera of an eye-tracking system, the non-transitory memory comprising instructions to use the eye-tracking system to determine the current eye position.

14. The non-transitory memory of claim 8, wherein the sensor comprises a 3D scanner for scanning a face of the user, the non-transitory memory comprising instructions to use the 3D scanner to determine the current eye position.

15. A wearable display system comprising:
a headset comprising:
a headset body;
a display module in the headset body, the display module comprising an electronic display for displaying images to a user of the headset;
a sensor in the headset body, wherein the sensor is configured for determining an eye position of the user; and
a processing module configured to:
use the sensor to determine an offset of a current eye position of the user wearing the headset, relative to an optimal eye position in an eyebox of the headset;
determine a direction of adjustment of the headset to lessen the offset; and
provide an instruction to perform the adjustment of the headset in the determined direction.

16. The wearable display system of claim 15, further comprising a motorized stage in the headset body, wherein the motorized stage is supporting at least a portion of the display module,
wherein the processing module is further configured to at least one of translate or reorient the at least a portion of the display module to lessen the offset.

17. The wearable display system of claim 16, wherein the motorized stage is supporting the display module, and wherein the processing module is configured to at least one of translate or reorient the display module to lessen the offset.

18. The wearable display system of claim 16, wherein the display module comprises an imaging component for conveying images generated by the electronic display to the eyebox, the imaging component being supported by the motorized stage; and
wherein the processing module is further configured to at least one of translate or reorient the imaging component to lessen the offset.

19. The wearable display system of claim 15, further comprising an eye-tracking system for tracking position and orientation of eyes of the user, wherein the sensor comprises a camera of the eye-tracking system;
wherein the processing module is further configured to use the eye-tracking system to determine the current eye position.

20. The wearable display system of claim 15, wherein the sensor comprises a 3D scanner for scanning a face of the user, wherein the camera is a part of the 3D scanner;
wherein the processing module is further configured to use the 3D scanner to determine the current eye position.
